(19) United States
(12) Patent Application Publication
(10) Pub. No.: US 2007/0209688 A1
(43) Pub. Date: Sep. 13, 2007

(54) Pendulum Umbrella

(75) Inventor: John Michael Earnshaw, Upper Cumberworth (GB)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: HOYLAND FOX LIMITED, Sheffield (GB)

(21) Appl. No.: 10/583,363

(22) PCT Filed: Dec. 20, 2004
(86) PCT No.: PCT/GB04/05351

§ 371 Date: May 31, 2007

(30) Foreign Application Priority Data
Dec. 19, 2003 (GB) 0329513.6

(51) Int. Cl. F16M 11/00

(52) U.S. Cl. 135/16; 248/689

(57) ABSTRACT

A clamp 10 for holding two elongate members 23a, 23b so that they extend at a preset angle from each other, comprising: two clamp portions 12, 14 each having co-operating engaging surfaces 16a, 16b, each clamp portion having an axial bore 18a, 18b extending perpendicularly to the engaging surfaces and a receiving portion for holding one of the elongate members; a stem or rod 19, passing through the bore of the clamp portions and attached at one end to a lever or handle 20 for rotating the stem in the bore, and a cam acting between the stem and at least one of the clamp portions so that the clamp portions can be moved from a position in which the engaging surfaces are not engaged to a position in which the engaging surfaces co-operatively engage by rotating the lever by approximately 90°.

An umbrella assembly 40 comprising an umbrella head and a pole 42 for supporting the umbrella head, the umbrella head having a runner slidably mounted on a shaft portion of the umbrella head and stretchers extending radially from the said runner to the ribs, and a clamp 10, 10′, 10″ for releasably attaching the umbrella head to the pole.

The present invention relates to a clamp for clamping two elongate poles together, and to a pendulum umbrella, in which the head of the umbrella, which is usually based on a short pole or stub pole, is supported from above by being clamped to a supporting pole, in particular by such a clamp. The invention is also concerned with umbrella-type assemblies that can be built up using such clamps.

Clamps are known for a variety of uses, such as clamping scaffolding parts or foldable stands. However, such clamps have the disadvantage that a large amount of work must be done to disengage the clamp to free or move the clamped objects.

By way of example, U.S. Pat. No. 5,370,570 discloses a portable mobile, for use on an infant's cot. An umbrella structure is rotatably mounted on a support system, including a pair of beams. The support system can be clamped by a clamping assembly to a variety of fixtures, such as chairs, tables, car windows, cribs and playpens. The beams are pivotable with respect to this clamping assembly. The lowest beam may be clamped in a desired orientation to a base piece so that it can support the mobile in a cantilever fashion. This clamping is achieved by tightening a screw that presses together two sets of coarse teeth against each other. This device would not be suitable for supporting any substantial weight and is of limited application.

EP 586173 (Black & Decker Inc) shows a clamp for two plate-like members through which a bolt passes, a lever and clamp device being used for quick locking and release. It is not clear how this could be used for umbrellas.

It is desirable to provide a more versatile umbrella configuration, and the invention sets out to achieve this.

In a first aspect, the present invention envisages a clamp for holding two elongate members so that they extend at a preset angle from each other, comprising: two clamp portions each having co-operating engaging surfaces, each clamp portion having an axial bore extending perpendicularly to the engaging surfaces and a receiving portion for holding one of the elongate members; a stem or rod, passing through the bore of the clamp portions and attached at one end to a lever or handle for rotating the stem in the bore, and a cam acting between the stem and at least one of the clamp portions so that the clamp portions can be moved from a position in which the engaging surfaces are not engaged to a position in which the engaging surfaces co-operatively engage by rotating the lever by approximately 90°.

The lever preferably extends radially substantially more than the diameter of the stem, and allows the user to switch the clamp between fully open and fully closed in only a right-angle turn, which implies ease of use. The lever advantage means that within this range an axial travel of several millimetres is possible, so the engaging parts, e.g. teeth, can be this high and hence robust.

Preferably there is a cam acting in both directions of movement of the lever, so that the lever can be used to disengage the parts positively also.

The clamp should be capable of holding the elongate members so that their axes can be inclined in a variety of orientations, preferably over a full 360°. The holding means for the elongate members can simply be a tube, preferably integral with the clamp portions, extending perpendicularly to and with its axis offset from the interlocking plane of the clamp portions. For full freedom of movement the tube should not be intersected by this plane. The elongate members can be fastened in the tubes by screws. The clamp can conveniently be made of plastics material such as nylon and held together by a snap-fit so that it is easy to assemble.

The cam can be formed of a radial lug on one part, say the rod or stem, and a track on the other part, say one of the clamp portions, extending over a quarter turn and inclined to the radial plane. Alternatively, each part can have an extended track so as to form something like a screw thread or partial thread.

A clamp of this type can be used to hold the poles of an umbrella-type frame. This enables a great variety of umbrella configurations, particularly if the umbrella's furling mechanism is self-contained on the shaft of the umbrella head. A simple application is a pendulum-type umbrella, i.e. one where the umbrella head is supported on a cantilever rather than a central shaft. This frees more space under the canopy. With the invention the umbrella head can be detachable from the cantilever. The cantilever can in turn be clamped to an upright pole. Further, one can fix two cantilever poles to a single support pole, with an umbrella head on each cantilever pole.

DE 41 0 5479 A1 discloses an umbrella having two umbrella heads on one shaft but there is no freedom of adjustment.

FR 2 752 511 and 2 752 512 disclose a “pendulum umbrella” which can be unfurled using a rope which passes through the shaft of the umbrella, connecting the head of the umbrella to a handle disposed on the shaft. Accordingly, this shaft is necessarily in a fixed configuration.

EP 1 279 350 A1 discloses a pendulum umbrella which can be unfurled by turning a handle on the stub pole. There is no discussion of the clamps that hold the portions of the main shaft together, and the shaft portions clearly cannot be dismantled.

The invention in this second aspect thus concerns an umbrella assembly comprising an umbrella head and a pole for supporting the umbrella head, the umbrella head having a runner slidably mounted on a shaft portion of the umbrella head and stretchers extending radially from the said runner to the ribs, and an adjustable clamp for releasably attaching the umbrella head to the pole.

The clamp should be located at the top of the umbrella head, that is, normally at the “notch” end of the pole remote from the runner. This means that the clamp does not interfere with the operation of the runner. Consequently, the umbrella head can be fitted into the clamp before the cover is unfurled, which makes it easier to slide the runner onto the shaft and open the canopy.

Attaching the head to the pole by a releasable and adjustable clamp allows a great variety of configurations. Preferably there are at least two elongate poles for supporting at least one umbrella head, one vertical and one cantilevered, similarly clamped together. More than one head can be supported on one cantilevered shaft, and/or more than one cantilever on one upright pole. Alternatively, a cantilevered pole can simply be attached to a fixture, such as a wall bracket or a pergola.

A plurality of elongate poles may be provided for supporting a plurality of umbrella heads so as to make up a matrix of umbrellas suspended from a framework made of poles clamped together. Because the clamps are releasable and allow adjustment of both angle and longitudinal position of the two poles, a framework can be constructed in which cantilever ends are attached to each other, giving a robust scaffold supported on a small number of upright poles. The invention is thus also concerned with a kit of parts consisting of poles and clamps of this type. The clamps are preferably identical, for convenience.

For a better understanding of the invention the present invention will now be described, by way of example only, with reference to the following drawings, in which:

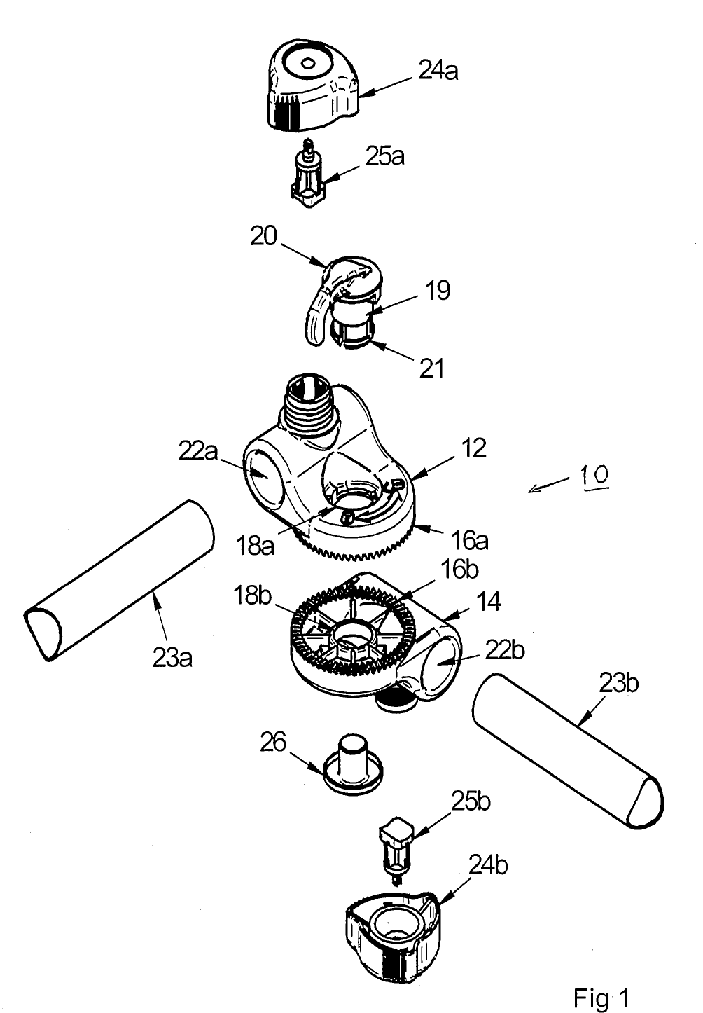

FIG. 1 shows an exploded view of a clamp according to an embodiment of the invention;

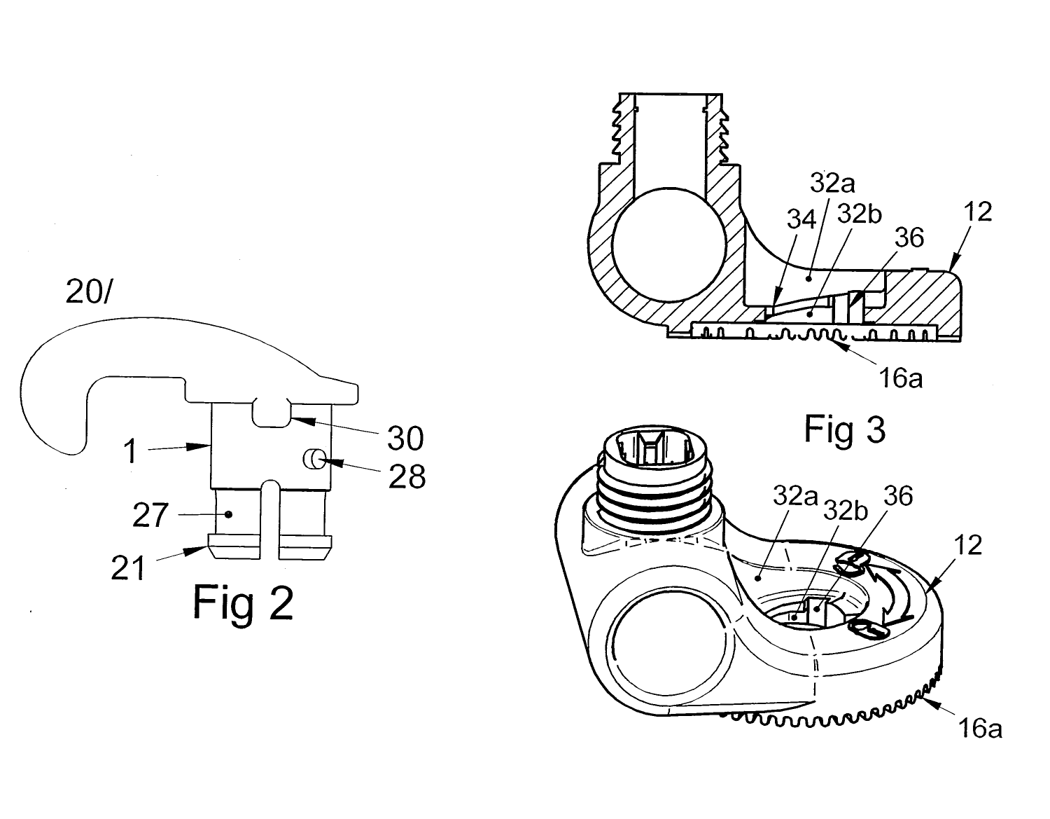

FIG. 2 shows a view of the lever of FIG. 1;

FIG. 3 shows sectional and perspective views of the first or upper clamp part;

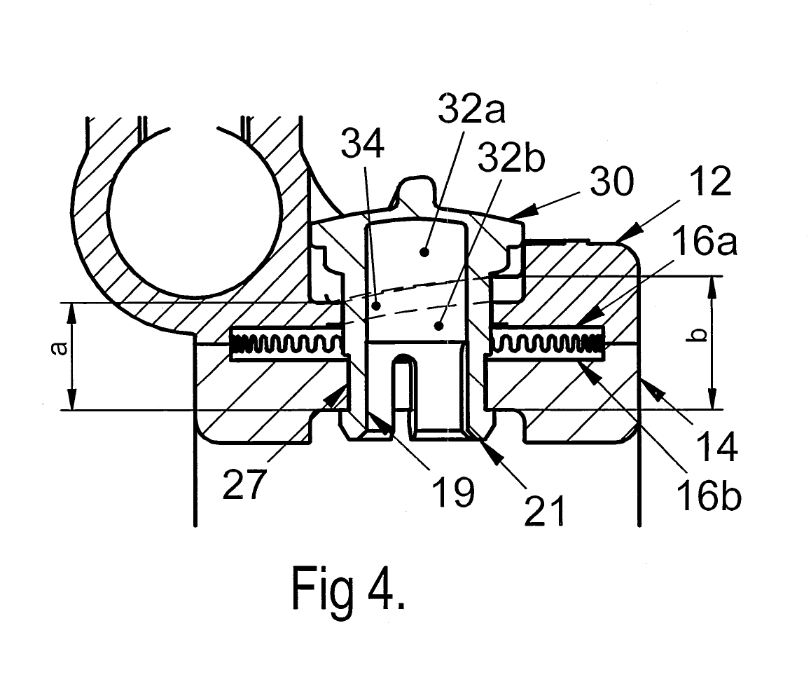

FIG. 4 shows a section through the assembled clamp;

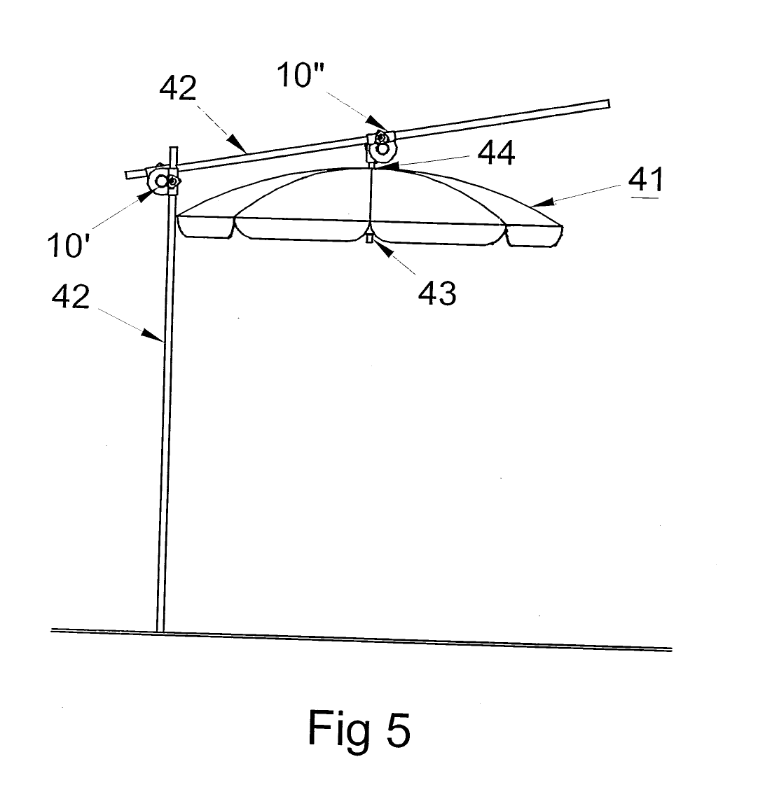

FIG. 5 shows a pendulum umbrella fitted with a clamp according to an embodiment of the present invention;

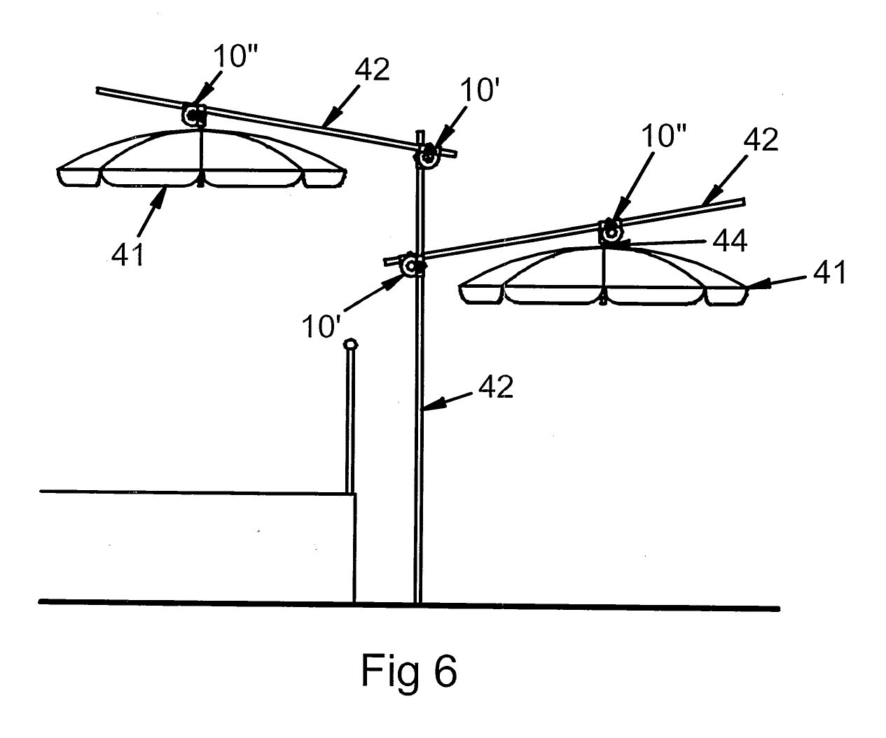

FIG. 6 shows an arrangement whereby two pendulum umbrella heads are supported by clamps according to an embodiment of the present invention;

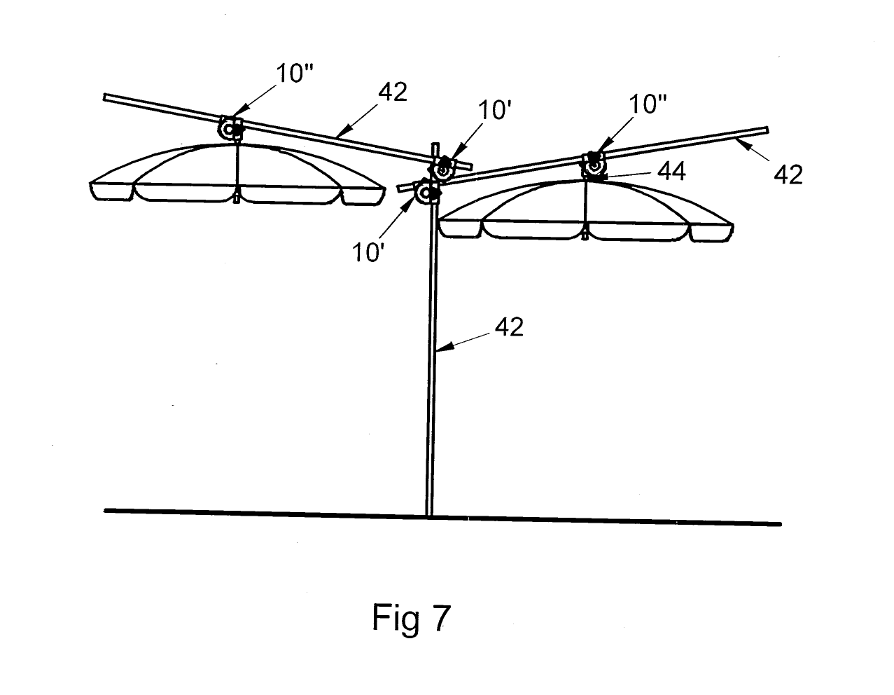

FIG. 7 shows an arrangement whereby two pendulum umbrella heads are supported by clamps according to an embodiment of the present invention;

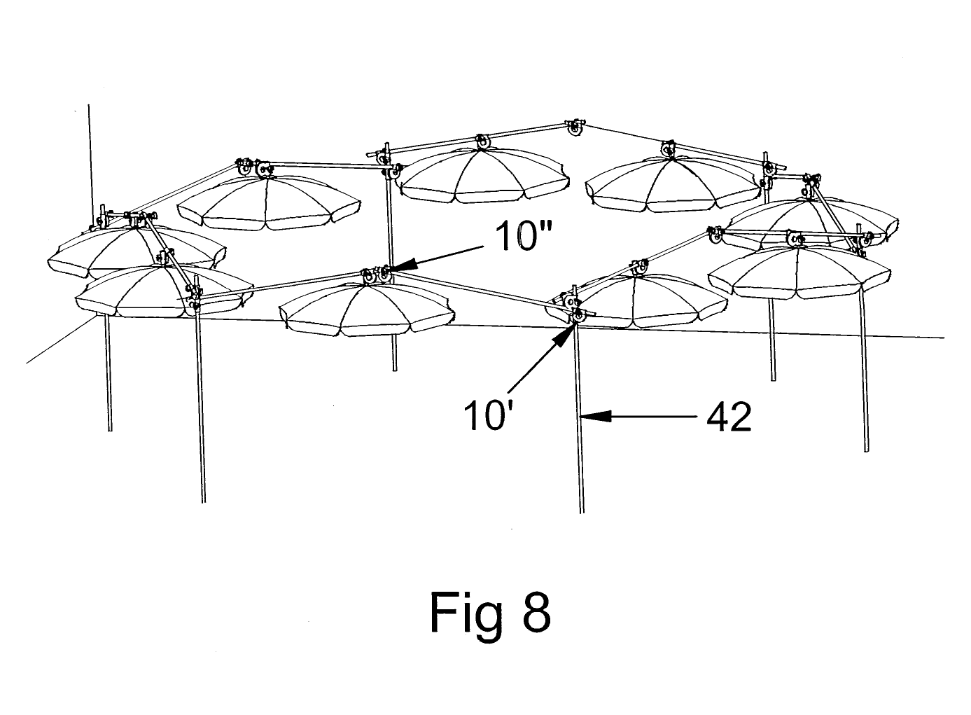

FIG. 8 shows an arrangement whereby a number of pendulum umbrella heads are supported by clamps according to an embodiment of the present invention;

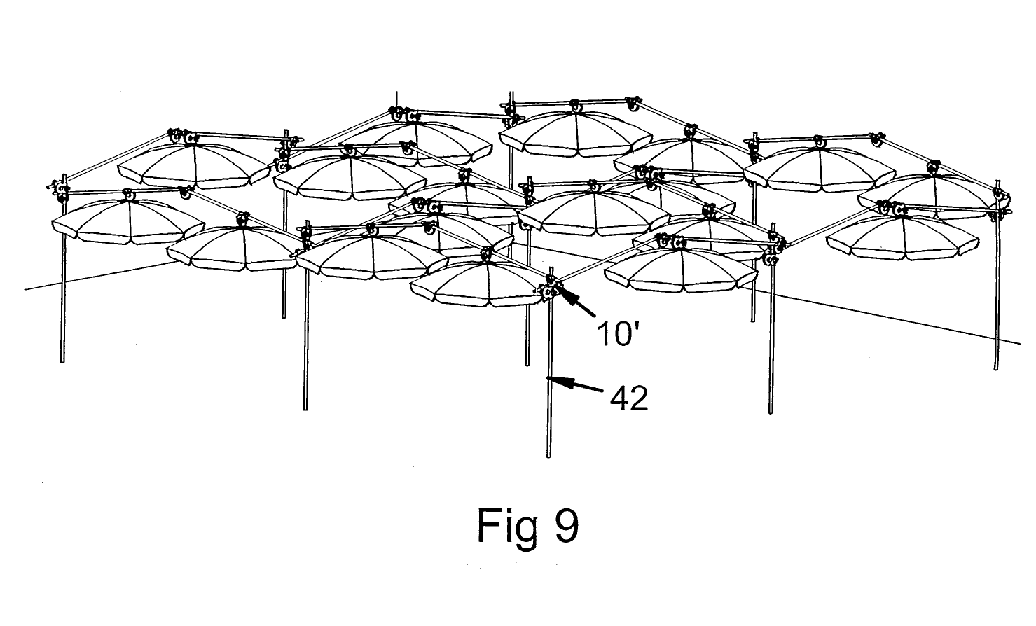

FIG. 9 shows an arrangement whereby a large number of umbrella heads are supported by clamps according to an embodiment of the present invention; and

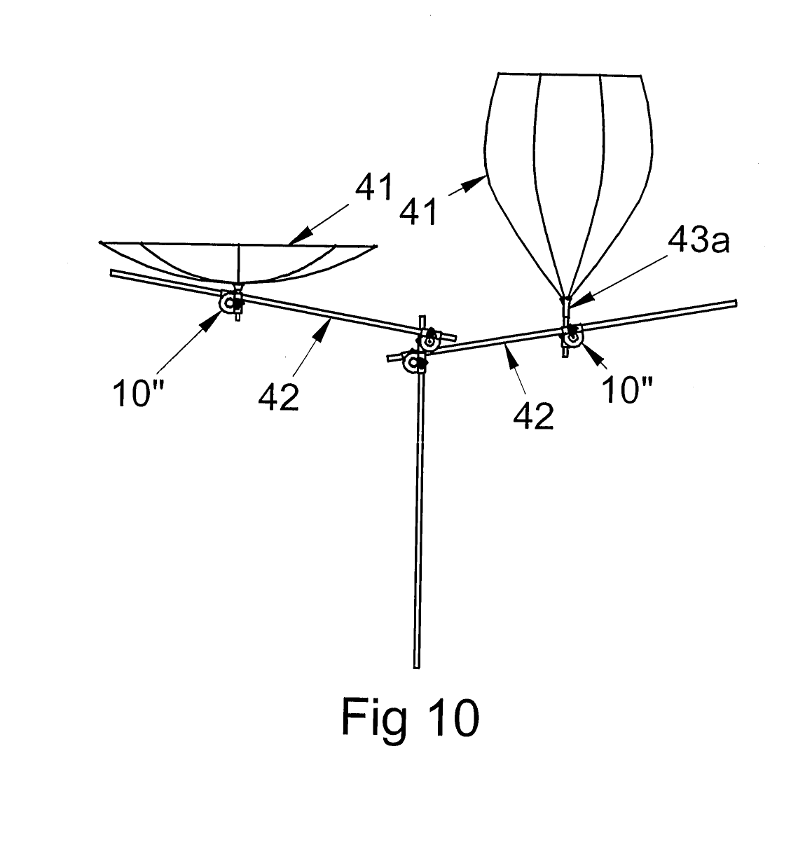

FIG. 10 shows a double-cantilever arrangement with alternative umbrella heads.

Before describing the type of umbrella envisaged by the invention, we first describe the preferred clamp that makes possible many umbrella arrangements. Turning to FIG. 1, this shows generally the parts of a clamp 10, comprising a first clamp portion 12 and a second clamp portion 14, having co-operating disc-like engaging surfaces 16a and 16b in the form of a ring of radial teeth, and respective corresponding bores 18a and 18b running through the centre of the discs, forming an axis of rotation for the discs. The stem 19 of a lever 20 passes through the bores 18a and 18b. The stem has a radial flange 21 disposed thereon at the other end, remote from the lever, so that the first and second clamp portions may be located on the stem of the lever.

The first and second clamp portions include integral tubes 22a and 22b, into which poles 23a and 23b or other such elongate items can be inserted, so that each clamp portion holds one pole. Once this longitudinal position is decided the poles can then be secured in the tubes by screw clamp hand wheels 24a and 24b, penetrating into the tubes and holding the poles with clamp pads 25a, 25b. This ensures that the tubes of the clamp portions are held securely when the clamp is assembled. A female thread (not shown) inside the handwheels 24a, 24b engages with a male thread on the first and second clamp portions 12, 14. Tightening the respective handwheels tightens the clamp pads against the poles 23a, 23b.

The tubes 22 are located clear of the engagement plane of the teeth 16, so that the two halves of the clamp can be rotated without obstruction. The tubes 22a, 22b can thus be rotated relative to each other so that the axes of poles 23a, 23b fitted therein are parallel or skewed as desired. A plug 26 is provided for maintaining the rigidity of the stem 19 in the bores 18a, 18b, and also for keeping the lever captive in the lower clamp portion 14. The plug is inserted into the lower bore 18b and further into the stem 19 of the lever, and jammed in.

FIG. 2 shows the lever 20 in more detail. From this Figure the profile of the stem 19 of the lever can be seen. A locating portion 27 having a narrower diameter than the rest of the stem 19 is provided, flanked on one side by a flange 21, and on the other by a step formed by virtue of the fact that the other part of the stem has a larger diameter. The portion of the stem having the larger diameter is provided with a pip 28. There is further provided a protrusion or lug 30 on this portion of the stem, somewhat spaced circumferentially and axially from the pip 28. FIG. 2 also shows how the flange end of the stem 19 is split to allow it to be press-fitted into the central holes 18 in the clamp halves. As mentioned above the plug (not shown in FIG. 2) is inserted into the stem to prevent the split ends from bowing inwards, and also for cosmetic reasons.

The first clamp portion, shown in FIG. 3, includes two parallel upper and lower tracks 32a and 32b having a common profile in the form of an internally facing ledge 34, disposed between the two and separating the tracks. The tracks are disposed on the inside surface of the axial bore 18a in the first clamp portion. The tracks on the first clamp portion are shaped so that one end each of the tracks is closer to the engaging surface 16a of the first clamp portion. In the assembled clamp, the pip 28 on the lever stem moves on the lower track 32b, and the protrusion 30 moves in the upper track 32a. Therefore, as the lever is rotated the pip 28 and the protrusion 30 ride over their tracks. By virtue of the contact of either the pip or the protrusion on the shaped profile 34 of the track the two clamp portions are drawn closer to or further away from each other by rotating the lever.

On assembly of the clamp the stem 19 of the lever 20 is inserted into the first clamp part 12, the pip 28 passing into its track 32b at an entry point or groove 36. This entry point corresponds to the highest point of this track (i.e. the point where the pip is located when the first and second clamp portions are nearest each other). The lever 20 is then turned through about 90° to the “unlocked” symbol on the upper clamp part 12, so that the lug 30 is at the bottom of its track 32a. At this point the lower clamp half is fitted over the flanged end 21 of the stem 19 and snaps into place. The lever can then be turned back towards the lock symbol to make the lug 30 ride on the upper track 32a, thus drawing the first and second portions closer together.

The range of movement of the lever is indicated in FIG. 3 by the moulded arrow between lock and unlock symbols. The track is shaped so that the co-operating engaging surfaces 16a, 16b on the clamp portions fully engage with each other when the pip is in the lowest position in the track. The first and second portions may be separated by rotating the lever the other way. In this case the pip bears against the lower track profile 32b and urges the upper and lower clamp portions apart. The track is shaped so that the lever need only be turned through approximately a right angle to bring the pip from the highest point of the track to the lowest point, at which the teeth 16 are fully engaged, thus giving rise to an easy clamping action.

FIG. 4 shows a cross-section of the assembled clamp, with the two clamp portions drawn together so that their teeth are in engagement with each other. From this Figure it can be seen that the profile of the cam track is such that the clamp portions can be drawn together, from spacing b to spacing a, by rotation of the lever. The clearance of the tube of the first clamp portion from the interlock plane is also shown, as is the way in which the second portion is held captive but rotatable in the narrow-diameter portion 27 of the stem 19. Furthermore, the role of the flange 21 in holding the lever captive on the first and second clamp portions can be seen. It and/or the bore of the stem 19 are slightly tapered so that a friction fit is created in the region above the split and sections. It can also be seen that there are in part two diametrically opposite protrusions 30, which ride on duplicated tracks in the upper clamp part 12, and likewise for the lugs 28. This prevents canting of the stem in the clamp.

After this description of the clamp, which makes possible adjustable configuration of poles, umbrella systems using such clamps will now be explained. FIG. 5 shows a pendulum umbrella 40, i.e. one in which the head 41 of the umbrella is supported from above or from the side, thus obviating the need for a support directly below the head of the umbrella. The umbrella head 41 has a shaft portion or stub pole 44 on which the runner 43 slides, coming off altogether when the umbrella is furled (closed). At the other end of the stub shaft, i.e. at the top, the shaft projects by a few inches (say 10-15 cm) beyond the top of the cover, and a clamp 10″ as described above is fixed to this protruding part.

The umbrella head in FIG. 5 is supported by a frame 42 made of two elongate poles, in this example one being substantially vertical and the other being more or less horizontal. The poles are attached together with a clamp 10; also as described above, and the stub pole 44 of the umbrella head is attached at the top of the head 41, above the notch, to the substantially horizontal pole with the head clamp 10″. It would also be possible to use different clamps for either or both of the joints.

To assemble the umbrella, the frame can first be set up, with the clamp 10″ on the cantilever; the umbrella head is then fixed in the clamp in its loose configuration, and the runner is then slid onto and up the stub shaft 44. This last operation is easy because the stub shaft is held firmly in the frame.

In use the configuration of the umbrella can be altered by loosening the clamps by turning the lever by approximately 90°, as mentioned above. Thus, the relative orientation of the two poles can be altered or the relative position of the umbrella head with respect to the substantially horizontal pole can be altered. Also the height of the horizontal pole up the vertical pole, and the distance of the head out along the horizontal pole, can be adjusted. Therefore, many different possibilities and configurations of the umbrella head and poles are possible.

Preferably, the shafts 42 and the inside of the clamp connector have matching longitudinal ribs or are otherwise of non-circular section, e.g. polygonal, to prevent the connector from rotating with respect to the shaft—in the wind, for example.

FIGS. 6 to 9 show more elaborate arrangements of umbrellas, fitted to frames with the clamps described above. FIGS. 6 and 7 show arrangements in which two umbrella heads are supported by one substantially vertical pole. FIG. 6 shows an arrangement in which the umbrella heads are at different heights, and FIG. 7 shows an arrangement in which the umbrella heads are at more or less the same height. These different arrangements may be useful for catering for different requirements; for example, in FIG. 6 umbrella heads are provided at the same distance from the ground for the two different ground levels shown in the Figure.

FIG. 8 shows a matrix of umbrellas whereby a number of umbrellas are linked together to provide an extended area of shade, for example. In this arrangement the ends of the cantilevers can be fixed together, using clamps as described above, or any clamps that connect two poles in an adjustable manner. The cantilevers can be extended and rotated at will, so that assembly is easy. The vertical poles can be planted in weighted stands, or directly in the ground if it is soft. Umbrellas can be connected in this way to make tents or awnings, in a manner reminiscent of that shown in WO 98/38406. However, in this document there is no leeway in the way that the umbrellas are fixed.

FIG. 9 shows a matrix of umbrellas where further umbrellas have been added to the arrangement shown in FIG. 7, so that an even greater area of shade is produced, and the amount of vertical supports needed is significantly fewer than for a corresponding number of separate upright umbrellas. Moreover this arrangement may produce a canopy of greater stability. Although the umbrellas preferably use the clamps of FIGS. 1 to 4, in principle any releasable clamps may be used if they have the necessary adjustability.

FIG. 10 shows an alternative double-cantilever umbrella where the umbrella heads are upside-down; this is mainly for decorative purposes. The left-hand head is similar to that shown in, say, FIG. 5, while the right-hand head is of the so-called inverted kind in which the runner 43a is attached to the ribs, like a kind of sliding notch, while the stretchers (not visible inside the globe-shaped cover) are fixed at their inner ends to the shaft. This is described in the applicant's patent application GB 0405767.5. Lamps may be fitted inside the covers. Here it may be more accurate to say that the “top” of the stub shaft 44, which here of course is the lower end during use, is the end on the opposite side of the cover to the ribs, so that the clamp does not interfere with the umbrella frame components.

1. An umbrella head designed to be supported on a pole, the umbrella head having a shaft portion ribs extending outwardly from the shaft portion to support a cover, a runner slidably mounted on the shaft portion and stretchers extending radially from the said runner to the ribs, and a clamp for releasably attaching the umbrella head to the pole, the umbrella head clamp being disposed at the top of the shaft.

2. An umbrella assembly including an umbrella head according to claim 1 and a pole to which the head clamp is attached in a cantilever fashion.

3. An umbrella assembly according to claim 2, including at least two poles for supporting the umbrella head, one substantially vertical and one cantilevered, the poles being clamped together and the cantilever being clamped to the umbrella head.

4. An umbrella assembly according to claim 2 and including at least two such umbrella heads.

5. An umbrella assembly according to claim 4 and including at least two standing poles and two cantilever poles, each pole being connected to at least one other pole connected in a matrix for supporting umbrella heads.

6. A clamp for holding two elongate members so that they extend at a preset angle from each other, comprising:
two clamp portions each having co-operating engaging surfaces, each clamp portion having an axial bore extending perpendicularly to the engaging surfaces and a receiving portion for holding one of the elongate members; and
an elongate stem or rod, passing through the bore of the clamp portions and attached at one end to a lever or handle for rotating the stem in the bore, and a cam acting between the stem and at least one of the clamp portions so that the clamp portions can be moved from a position in which the engaging surfaces are not engaged to a position in which the engaging surfaces co-operatively engage by rotating the lever in the bore in one direction by approximately 90°.

7. A clamp according to claim 6, in which the stem has a radial flange at the other end for holding the clamp portions together.

8. A clamp according to claim 6, in which the cam includes a track on one of the clamp portions, and a co-operating protruding element on the stem, the protruding element being arranged to ride on the track in use.

9. A clamp according to claim 8, and further having a cam mechanism for separating the clamp portions when the lever is turned in the other direction.

10. A clamp according to claim 6, in which the clamp is suitable for allowing a full 360° range of preset angles between the elongate members held therein.

11. A clamp according to claim 6, in which the engaging surfaces have interlocking elements such as teeth (16).

12. A clamp according to claim 6, in which the receiving portions are integral tubular parts for receiving poles or shafts, with securing means for holding the pole or shaft.

13. An umbrella assembly according to connected together by clamps according to claim 6.

14. An umbrella assembly according to claim 2, in which the umbrella head, or at least one of the heads, is upside-down with the runner uppermost and the clamp below the cover.

15. An umbrella assembly according to claim 2, in which at least one umbrella head is of the “inverted” type.

16. A kit of parts comprising poles, clamps and umbrella heads, that can be assembled to form an umbrella assembly according to claim 13.
